(19) United States
(12) Patent Application Publication
(10) Pub. No.: US 2013/0024113 A1
(43) Pub. Date: Jan. 24, 2013

(54) Selecting and Controlling the Density of Objects Rendered in Two-Dimensional and Three-Dimensional Navigation Maps

(71) Applicants: Fuliang Weng, Mountain View, CA (US); Liu Ren, Cupertino, CA (US)

(72) Inventors: Fuliang Weng, Mountain View, CA (US); Liu Ren, Cupertino, CA (US)

(73) Assignee: Robert Bosch GmbH, Stuttgart (DE)

(21) Appl. No.: 13/188,574

(22) Filed: Jul. 22, 2011

(51) Int. Cl. G01C 21/36; G06T 15/00

(52) U.S. Cl. 701/455; 345/419; 701/450

(57) ABSTRACT

A method of displaying an electronic map includes receiving map data associated with a plurality of objects that are disposed within a geographic area. The map data is analyzed to thereby determine a state or value of a metric associated with one of the objects. The associated object is rendered in a low density or high density within the map depending upon the state or value of the metric.

### BACKGROUND OF THE INVENTION

1. Field of the Invention

The present invention relates to electronic navigation maps, and, more particularly, to rendering images for electronic navigation maps.

2. Description of the Related Art

Navigation maps are essential resources for visitors to an unfamiliar city because these maps visually highlight landmarks including buildings, natural features, and points of interest such as museums, restaurants, gas stations, parks and shopping districts. While most in-car navigation systems and portable navigation devices (PNDs) rely on two-dimensional (2D) navigation maps to visualize these landmarks in 2D, three-dimensional (3D) in-car navigation systems are emerging.

Using a 3D map for navigation can provide a lot of benefits. For example, a 3D map can provide better driver orientation than a 2D map because people live in a 3D world and thus are naturally more adept at perceiving in 3D. A 3D map can also improve landmark recognition as the important features (e.g., geometry, structures, textures) of 3D buildings/landmarks can be fully exposed so that it will be a lot easier for a user to match these features with what he could see through the windshield.

However, introducing landmark information in 2D or adopting 3D in a navigation map also increases a driver's cognitive load and potentially confuses the driver as a lot more information is presented to the driver as he is driving. FIG. 1 shows a typical 2D navigation map where the route 30 can be clearly displayed, such as in colored lines. However, in the example 3D navigation map of FIG. 2, route guidance is significantly occluded in the 3D navigation map because of the high number of 3D buildings rendered in this city scene. For example, buildings 32 may occlude, or block the user's view of, a route 34 that is indicated in FIG. 2 by a dark line.

Some methods have been adopted to reduce the occlusion effects in a 3D map. For example, one typical solution is to visualize the route guidance from a bird's-eye view, or a view point far away from the land. But such a viewpoint is not the one most drivers are comfortable with. Moreover, it may not be possible for the viewer to see the 3D details of buildings clearly enough to recognize the building details as being in 3D—which essentially reduces the 3D into 2D and largely loses the advantage of 3D navigation over 2D navigation. Another approach is to render a few buildings (especially those closest to the viewer) with transparency. For example, building 36 in FIG. 2 is rendered with transparency such that route 34 is visible behind building 36. However, as evident in FIG. 2, this approach leads to a visual confusion in the viewer's perception of what is the route and what is the building and where the route and the building are in relation to each other. In addition, this building transparency approach may not provide a clear route guidance for the driver.

Even with the latest 3D non-photorealistic rendering technology that already addresses certain drivers' orientation issues, the high density of 3D objects to be presented may still be a problem for some people at certain times. For example, when landmark buildings, non-landmark buildings and POIs are all included in the same 3D navigation map, it can be very overwhelming for some drivers. An example of such a map in which POIs, landmarks, non-landmark buildings, and street labels are all displayed in a single 3D Nonphotorealistic (NPR) map is illustrated in FIG. 3.

What is neither disclosed nor suggested by the prior art is a method for presenting 2D and 3D objects on a navigation map that overcomes the problems and disadvantages described above.

### SUMMARY OF THE INVENTION

The present invention may provide a method of selecting and controlling the rendering density of objects rendered in 2D and 3D navigation maps based on context and user preference. The invention may improve the orientation for the driver and reduce his cognitive loads. In addition, the invention may provide an opportunity to speed up the 3D navigation rendering or reduce the computing requirements as many non-interesting objects will not be rendered at various points in time. Objects rendered according to the invention may include landmarks, buildings, lakes, parks, or icons for gas stations, etc.

The invention comprises, in one form thereof, a method of displaying an electronic map, including receiving map data associated with a plurality of objects that are disposed within a geographic area. The map data is analyzed to thereby determine a state or value of a metric associated with one of the objects. The associated object is rendered in a low density or high density within the map depending upon the state or value of the metric.

The invention comprises, in another form thereof, a method of displaying a navigation map, including determining a route of a vehicle. Map data associated with objects that are disposed within a geographic area is received. The geographic area includes the route of the vehicle. The map data is analyzed to thereby determine a state or value of a metric associated with one of the objects. The state or value of the metric is dependent upon a position of the associated object relative to the route of the vehicle. The associated object is rendered in a low density or high density within the map depending upon the state or value of the metric.

The invention comprises, in yet another form thereof, a method of displaying an electronic map, including receiving map data associated with objects that are disposed within a geographic area. A plurality of metrics associated with the objects is identified. A selection of at least one of the metrics is received from a user. The map data is analyzed to thereby determine for each of the objects a state or value of the at least one selected metric. Each of the objects within the map is rendered in a density level that is dependent upon the state or value of the at least one selected metric corresponding to said object.

An advantage of the present invention is that it significantly improves the visual clarity of the routes in the 3D navigation display, and thus improves the user experience.

Another advantage of the present invention is that cognitive load on the user may be reduced by virtue of reducing the density of objects in the image that are of lesser interest to the user.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is an illustration of route guidance displayed on a 2D navigation map according to the prior art.

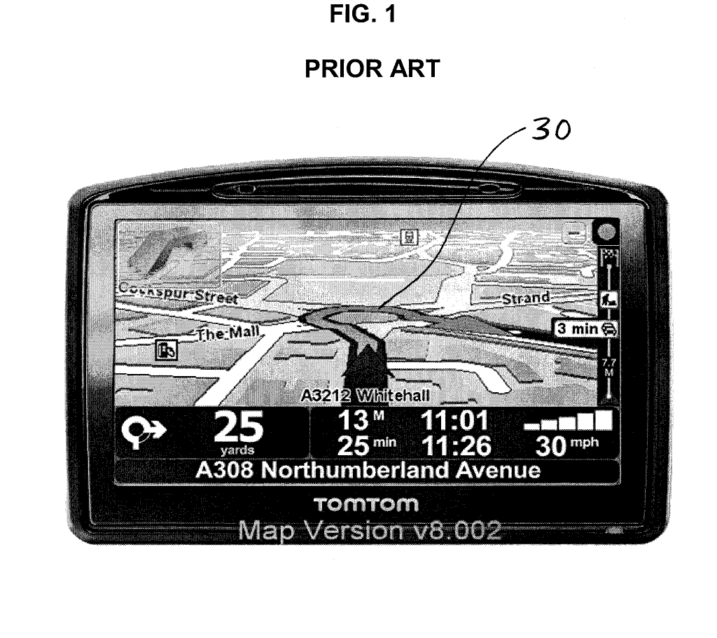

FIG. 2 is an illustration of route guidance that is partially occluded on a 3D navigation map according to the prior art.

FIG. 3 is one example of POIs, landmarks, non-landmark buildings, and street labels all being displayed in a 3D Nonphotorealistic (NPR) map according to the prior art.

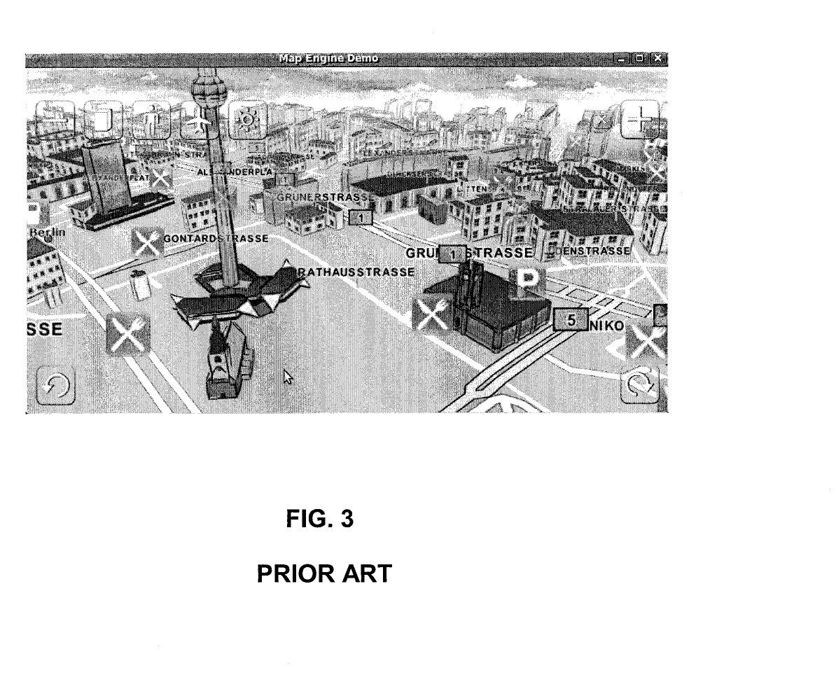

FIG. 4 is a block diagram of one embodiment of a map rendering arrangement of the present invention.

FIG. 5 is a flow chart of one embodiment of a method of the present invention for displaying an electronic map.

FIG. 6 is a flow chart of an embodiment of a method of the present invention for displaying an electronic navigation map.

FIG. 7 is a flow chart of another embodiment of a method of the present invention for displaying an electronic map.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

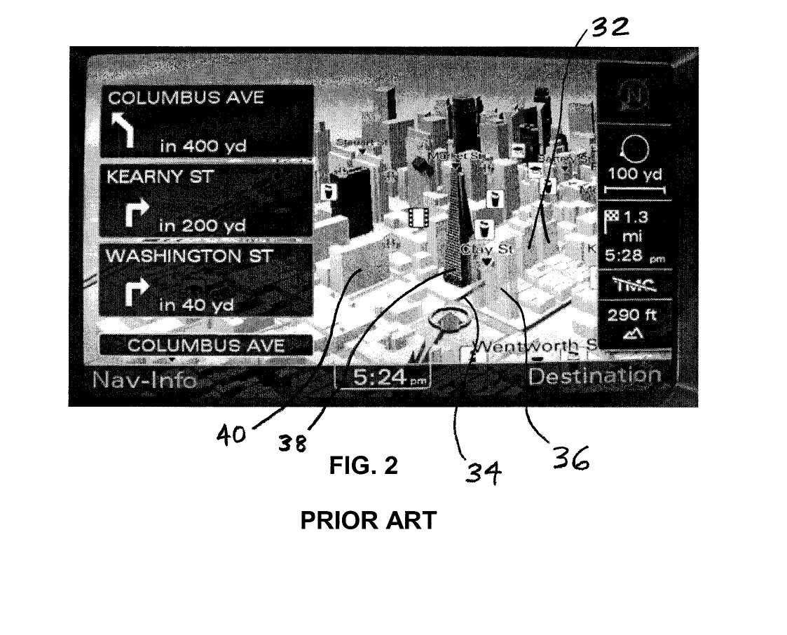

The invention may provide a method that would help the drivers to select and control the object density in the navigation map so that the drivers may reduce their own cognitive load when viewing the navigation map. In order to illustrate what may be meant by “rendering density,” building 38 in FIG. 2 happens to be rendered with a higher level of density than is building 40. That is, the left-hand surface of building 38 includes graphical detail that the depiction of building 40 does not have. More particularly, building 38 includes additional detail in the form of rows of windows which are visible on the left-hand surface of building 38.

In one embodiment of the invention, objects may be classified into different levels. The classification is based on the following dimensions: orientation dimension, route relevance dimension, and interest dimension.

Along the orientation dimension, the objects may be classified into different categories based on the importance of the individual objects in driving orientation. The importance metrics for driving orientation may include the visibility of the objects and the degree of differentiation between the objects and their neighboring objects. The importance metrics for driving orientation may also include the color, texture, size, and structure of the object. The familiarity of the object to the drivers may also be included in the importance metrics for driving orientation. For example, a McDonald's® restaurant sign on a building may have a high degree of familiarity with the drivers.

Along the route relevance dimension, the objects may be classified based on the distance between the object and the vehicle's planned route, and/or the distance between the object and the decision points (e.g., points at which the vehicle is to make a turn) along the route. The distance between the object and the route may be computed based on, or defined as, the distance between each object and its respective closest point on the route.

The distance between the object and the route may be computed first with respect to those objects that are nearest to the route, and may be computed last with respect to those objects that are farthest from the route. That is, the distances between the objects and the route may be computed in sequential order beginning with objects closest to the route and progressing with objects that are increasingly distant from the route. When a calculated distance equals or exceeds a threshold distance, the calculations may be ceased. Thus, the distance may not be calculated with respect to any object that is farther than the threshold distance from the route. Accordingly, computational cost associated with any object that is located beyond the threshold distance may be avoided.

In one embodiment, another metric included in the route relevance dimension is the additional driving distance and/or additional driving time that would result if the vehicle were to leave the planned route in order to drive to and visit the particular object. For example, in interstate highway driving conditions, an object or destination may be relatively close to the highway, but may not be near an exit of the highway. Thus, driving to the object may require driving several miles to the next exit and doubling back toward the object. Moreover, the off-highway driving to the object may be considerably slower than the highway speeds, particularly in urban areas. This additional driving distance/time metric may calculate the actual driving distance and/or time that visiting a given destination would add to the trip, rather than simply indicate the raw distance between the destination and the highway. Objects requiring less than a threshold additional driving distance or a threshold additional driving time to visit (or a combination of distance and time) may be rendered with a higher density level. This metric may be re-calculated in real time based upon which highway exits the vehicle has already driven by and thus cannot be taken by the vehicle. That is, objects that can no longer be easily driven to once a corresponding highway exit has been passed may have this metric re-calculated in real time such that the objects are rendered in lower density immediately after the vehicle has passed their corresponding highway exit.

Another factor in the route relevance is the placement of the turning points in the route. The objects that are disposed relatively close to the decision points may have and/or be assigned a higher importance than the objects that are disposed relatively far from the decision points. Such objects that are disposed relatively far from the decision points may be disposed next to, or closer to, the straight portions of the route.

Along the interest dimension, the two main factors that may be considered in the measurement are: whether the drivers are interested in the POIs; and whether the drivers are interested in other specified objects. An individual driver's level of interest can be specified by the driver explicitly through dialog systems, buttons or touch-based input devices, for example.

According to the invention, the user may be provided with the option to select the degree of the density of the displayed objects along each dimension explained above. Therefore, the driver may have control of the amount of information to be presented to him during driving.

In the meantime, a few default settings may also be provided for different age groups and for drivers with different tastes. For example, it may be known to the system that a restaurant such as Taco Bell® appeals to a younger demographic, while a cafeteria chain appeals to an older demographic. Accordingly, if the user expresses or inputs an interest in restaurants to be used as a metric, the system may render a Taco Bell® in high density and a cafeteria in low density for a younger user. Conversely, the system may render a Taco Bell in low density and a cafeteria in high density for an older user. As another example, the system may keep of what types of destinations a user has historically stopped at. If the user has historically stopped at a large number of McDonald's® restaurants, but has not stopped at any Taco Bell® restaurants, then the system may render McDonald's® restaurants in high density and Taco Bell® restaurants in low density.

The settings may be position-sensitive along a route. For example, within segments of the route having a large number of objects per unit area or per unit distance, the objects may be rendered with lower density in order to lower the cognitive load on the driver. Conversely, within segments of the route having a lower number of objects per unit area or per unit distance, the objects may be rendered with higher density based on an assumption that the driver would benefit from having more visual information about the objects.

The present invention as described above includes several novel features. A first such novel feature is that options may be provided for the users to select and control the density with which 2D or 3D objects are rendered on the navigation map, especially along the navigation route.

A second novel feature is that three dimensions and associated metrics associated with objects within the navigation map are provided. These dimensions and metrics may be used to compute the relevance of each of the objects to the users. The relevance of each object, in turn, may be used to control the density with which each object is rendered within the navigation map.

A third novel feature is that the driver may select a default setting for rendering density. Thus, the driver may be able to control the density level to thereby select a desired level of density to suit his needs at a particular time and place.

The present invention may provide the options needed for the user to select and control the rendering density of 2D or 3D objects on the navigation map, especially along the navigation route. For example, the user may select or indicate which objects in the map are of greater interest to him, and these objects of higher interest may be rendered with greater density. As another example, the user may select a subset of metrics to be considered when deciding upon a rendering density. Further, the user may provide weightings to be assigned to the various metrics when calculating a rendering density. The user may tailor the metric selections and/or weightings to the type of trip that he is taking, or to the purpose of the trip.

As a first use example, when the user is looking a fast food restaurant, he may enter “fast food restaurant” as a metric under the user-interest dimension. The user may further select or assign a greater weighting to the “familiarity” orientation metric. Thus, when a famous, or well known-to-the-user fast food restaurant such as a McDonald's® restaurant appears within the navigation map, the restaurant may be rendered with a greater density such that the representation of the restaurant stands out, or is more likely to catch the user's eye, in the navigation map. The same high density rendering of a McDonald's® restaurant may result solely from the user selecting or assigning a greater weighting to the “familiarity” orientation metric without expressing his interest in fast food in particular.

As another use example, assume that the user is on a sight-seeing in an unfamiliar city. Although he would like to visit or drive by unusual structures within the city, he may not know where such unusual structures are located. In order to find such out-of-the-ordinary landmarks on the navigation map, he may select or assign a greater weighting to the “differentiation” orientation metric. Thus, landmarks that are very different from the objects surrounding them, such as by virtue of being bigger or of different shape, for example, may be rendered with a greater density in the navigation map. Due to the landmarks' greater rendering density, the user may be able to more quickly and easily pick such noteworthy landmarks out of the navigation map.

As yet another use example, assume that the user has a route laid out on the navigation map with at least one upcoming turn being called for. Although the map and the turn-by-turn directions clearly indicate the street(s) he should turn onto, he has difficulty seeing the real-world street signs through his car window. Thus, the user would like to identify more prominent landmarks near his upcoming turns so that he will know to execute the turns when he sees the prominent landmarks through his window. However, the user cannot easily see any such prominent landmarks on the navigation map that are near the turns, so he is having trouble identifying landmarks to look for through the window. According to the invention, the user may select or give increased weighting to the distance-to-decision point metric in the navigation system. Thus, the rendering of the navigation map may be adjusted such that landmarks that are closer to “decision points” or turns are depicted with greater detail on the navigation map. With this greater level of detail being provided for landmarks near the upcoming turns, the driver can more easily match the real-life landmarks to the renderings of the same landmarks on the navigation system. Thus, the driver may know to turn when he recognizes one or more of these landmarks through his car window.

As still another use case, assume that the user has no intention of deviating from his planned route, and thus has no interest in landmarks that he is not able to see through his car window. Thus, the user may likewise be interested in seeing on the navigation map only those landmarks that he is also able to see through his car window. Accordingly, the user may select or give increased weighting to the visibility metric in the navigation system. Thus, those objects that are visible to the driver when driving along the planned route may be rendered with a greater degree of detail density. Advantageously, the user may then be able to recognize the objects that he sees through his car window by virtue of the increased detail with which the same objects are rendered in the navigation map. Hence, the user may gain knowledge or information that may be provided by the navigation system about the visible objects.

Whether another object is disposed between the object in question and a point on the route that is closest to the object in question may be used as a proxy for whether the object in question is adjacent to the route. Such adjacency to the route may be used as a metric in some embodiments. Further, whether another object is disposed between the object in question and a point on the route that is closest to the object in question may be used as a proxy for whether the object in question is visible to the driver. The relative heights and/or widths of the object in question and the other, view-obstructing object may also be a factor in the determination of whether the object in question is visible to the driver. For example, if the other object that is closer to the road is taller and wider than the object in question, then it is likely that the object in question is not visible to the driver.

As a further use case, assume that the user would consider making a stop for gasoline or food, but only if the retail establishment is within a couple of miles or so of his planned route. In order to more easily find such establishments, the user may select or give increased weighting to the distance-to-route metric in the navigation system. Thus, those objects that are within a predetermined distance of the planned route may be rendered with a greater degree of detail density. This predetermined distance may be calibratable or adjustable by the user. In addition, the user may have indicated that he has a high level of interest in retail establishments, and thus any retail establishments within the navigation map may also be rendered with a greater degree of detail density. In one embodiment, all objects in the navigation map that meet either of the two criteria (i.e., are disposed within a predetermined distance of the planned route or are a retail establishment) are rendered with a greater degree of detail density. In another embodiment, all objects in the navigation map that meet both of the two criteria (i.e., are disposed within a predetermined distance of the planned route and are a retail establishment) are rendered with a greater degree of detail density. In yet another embodiment, all objects in the navigation map that meet one of the two criteria (i.e., are disposed within a predetermined distance of the planned route or are a retail establishment) are rendered with a first degree of detail density that is greater than the normal degree of detail density, and all objects in the navigation map that meet both of the two criteria (i.e., are disposed within a predetermined distance of the planned route and are a retail establishment) are rendered with a second degree of detail density that is greater than the first degree of detail density.

As described above, the level of interest that the user has in certain metrics may be manually and/or orally specified or inputted by the user. However, it is also possible for the level of the user's interest in certain metrics to be assumed, perhaps based on other measured parameters or sensor readings that may be taken automatically. For example, a gasoline gauge reading of less than one-quarter tank may cause the system to automatically assume that the user has a high degree of interest in service stations or gasoline stations, and thus such stations may be rendered with a high level of detail.

As another example, a diagnostic sensor that detects that the vehicle needs service (e.g., a sensor that energizes a “check engine” light, a sensor that detects low tire pressure, a sensor that detects a high coolant temperature, or a sensor that detects a low level of engine oil) may cause the system to automatically assume that the user has a high degree of interest in automobile dealers that service the same make of vehicle as the make of the vehicle in which the inventive system is installed. According to the invention, such automobile dealers may be rendered with a higher level of detail.

As yet another example, at traditional meal times (e.g., noon to 1 p.m., or 6 p.m. to 7 p.m.) as sensed by an in-vehicle clock, it may be automatically assumed that the user has a high degree of interest in restaurants, and thus restaurants may be rendered with a high level of detail only during those traditional meal times. Further, the rendering of restaurants with a higher density may continue past 1 p.m. or 7 p.m. in the event that in-vehicle sensors determine that the car has been in substantially constant motion, and/or has not even slowed enough to go through a restaurant's drive-thru, during the entire noon to 1 p.m. or 6 p.m. to 7 p.m. time period.

By virtue of the interest metric, the increased density rendering method of the invention may be personalized. The user may specify what kind or category of buildings or other objects along the route is to be highlighted in order to enable the user to more easily recognize the real life buildings/objects and/or better convey the route information. Dependent upon the interests of the user, the buildings rendered in higher density may be only restaurants, only hotels, only buildings having a height or width along the route above a certain threshold height or width, only buildings that have signage that is lit at night, or other types or categories of buildings. The user can also specify a combination of different types of 3D buildings that are to be rendered in higher density. For example, the user may specify that only non-residential buildings having a width greater than 100 feet along the route are to be rendered in high density.

In general, the system can also allow the driver to select a limit on how many of these objects should be rendered in higher density. For example, the user may specify that only one building in each block along the route be rendered in high density. In another embodiment, the user may disable all metric selections except for the metrics under the orientation dimension and may further specify that only the single most prominent building on each block be rendered in high density. The building prominence may be determined based upon one metric or some combination of the orientation metrics of visibility, differentiation, color, texture, size, structure, familiarity, and perhaps fame. Values or states for these orientation metrics may be provided in a lookup table in memory. The user may specify a number of buildings per block to be rendered in high density, wherein the number is greater than one. Or, the user may specify that only one building be rendered in high density per a selected number of blocks (e.g., the user may specify that only one building is to be in high density in any group of four contiguous blocks).

In another embodiment, the user may combine the selection of metrics for high density rendering with a limit on the number of objects to be rendered in high density. For example, the user may request that only buildings having retail shops as tenants be rendered in high density, with a maximum of three such buildings being rendered in high density per block. If more than the specified maximum number of buildings meet the criteria, then the buildings to be included in the maximum number may be selected by the system based on building prominence, which may be determined as described above.

As another use case, the user may select one or more metrics in the orientation dimension in order to facilitate or enhance his ability to recognize the real-life objects that are depicted in the navigation map. For example, the user may select one or more of the visibility, color, texture, size and structure metrics as a basis for rendering the object in higher density. In one embodiment, selecting the visibility metric results in objects that are not easily visible (e.g., objects that are above street level or that are obstructed by another object) being rendered with increased density so that the user may more easily recognize the object when he does see the object in real life. In another embodiment, selecting the color metric results in objects that are of a common or nondescript color (e.g., grey), or of a color that is close to that of surrounding objects, being rendered in higher density such that the user can more easily distinguish the object from its surrounding objects. In yet another embodiment, selecting the texture metric results in objects that have little or no texturing being rendered in higher density. A rationale for this treatment is that objects with little or no texturing can afford to have more detail added to them without becoming too cluttered with markings. In still another embodiment, selecting the size metric results in objects that are relatively large compared to other objects in the map being rendered in higher density. Similarly to the texture rationale, large objects may have more room for additional detail without danger of becoming too cluttered with markings. In a further embodiment, selecting the structure metric results in objects that have relatively simple structures with few edges being rendered in higher density. Similarly to the texture and size rationales, objects that do not have many edges and complicated shapes may have more room for dense rendering without unduly increasing the cognitive load on the viewer.

In another embodiment, another metric in the route relevance dimension that may be employed is whether or not the object is disposed adjacent to the street of the planned route. That is, is there any other object between the object and the closest point on the street along the route? If this metric is selected by the user, then those objects that are adjacent to the planned route may be rendered with a higher degree of density than are objects that are nonadjacent to the planned route. Rendering objects that are adjacent to the route with higher density may serve to make the location of the route in the display more visually clear. The objects to be the subjects of such increased density may be chosen to be on only one side of the route (e.g., left- or right-hand side of the traveller, or on the far side of the route from the viewer) or both sides of the route.

Advantageously, the invention may enable the user more easily recognize the objects that he sees through his car window by virtue of the increased detail with which the same objects are rendered in the navigation map. Hence, the user may more easily gain knowledge or information that may be provided by the navigation system about the visible objects.

As described above, a specific embodiment of the invention provides three dimensions and associated metrics that can be used to compute the level of density with which objects within a navigation map may be rendered. The metrics described herein, particularly within the route relevance and interest dimensions, may be indicative of the level of relevance of a particular object to the user. Other metrics described herein, particularly within the orientation dimension, may be indicative of whether a specific object needs to be provided with increased density in order to be more recognizable to a user. Alternatively, or in addition, other above-described metrics, particularly within the orientation dimension, may be indicative of whether a specific object can afford to be provided with increased density without becoming too cluttered or unduly raising the cognitive load on the viewer.

The invention may provide a method and default setting that the driver can use to select and control the level of density such that the desired level of density may be achieved at the desired time to suit to the driver's particular needs at the time. That is, the driver may select the characteristics of objects that he is looking for such that such sought after objects are rendered in the navigation map with increased density. Moreover, the driver may adjust the overall rendering density of the navigation map to suit his needs. For example, if the driver is familiar with an area, or has less time to study the navigation map, he may want the navigation map to be rendered with a low overall level of density so that the map is easier to comprehend. Conversely, if the driver is unfamiliar with an area, or has more time to study the navigation map (e.g., the vehicle is traveling slowly, has come to a stop, or is parked), he may want the navigation map to be rendered with a higher overall level of density so that it may provide more information that the driver can use to find the objects he is looking for.

Although metrics have been described herein as being selected by a user in order to be implemented, it is to be understood that the invention encompasses default settings that may or may not be modifiable by the user. For example, the system may be installed with a particular set of metrics being automatically selected for high density rendering. Such an automatically selected set of metrics may be fixed such that it cannot be changed by the user. Alternatively, the set of metrics may be modifiable by the user, modifiable only automatically in response to in-vehicle sensor readings, or may be modifiable both by the user and automatically in response to in-vehicle sensor readings.

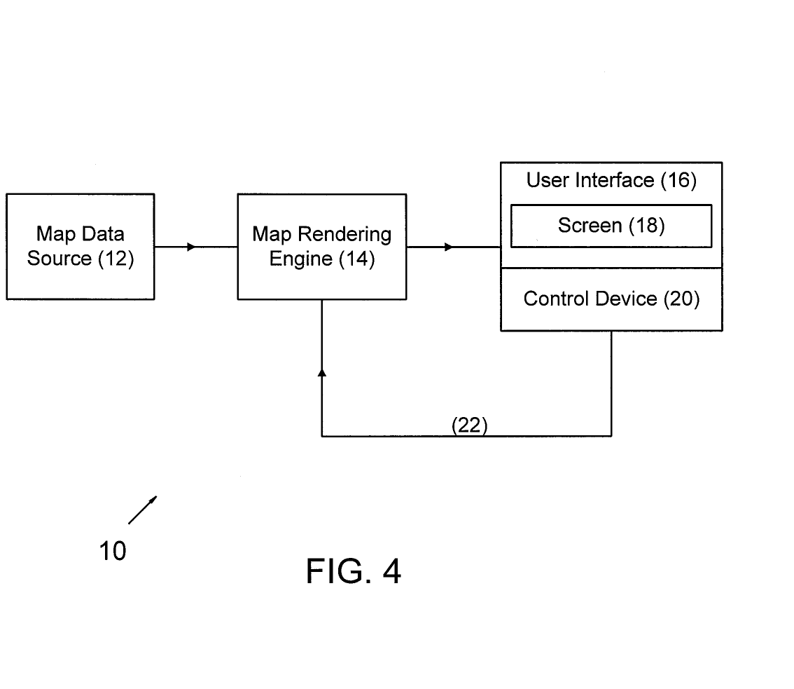

In FIG. 4 there is shown one embodiment of a 3D map rendering arrangement 10 of the present invention that may be associated with a vehicle, such as an automobile. That is, arrangement 10 may be installed in-vehicle.

Arrangement 10 may include a source 12 of map data, a map rendering engine 14, and a user interface 16. Map data source 12 may be in the form of a compact disc (CD) or other memory device. Alternatively, map data may be wirelessly transmitted by a central transmitter (not shown) to a large number of vehicles that each has a respective map rendering arrangement 10. Such wireless transmissions may be received by engine 14.

Map data source 12 may also include a global positioning system (GPS) module (not shown) for determining the global location coordinates of the vehicle in real time. Based on the current location of the vehicle, corresponding map data that is of interest to people within the vehicle is identified and provided to engine 14.

Map rendering engine 14 may include a standard electronic processor that converts the map data from source 12 into image data. During the course of rendering, engine 14 may select certain objects in the data based on criteria provided by the user and may render the selected objects with various levels of density (e.g., from low to high), as described above. In one embodiment, at least some of the image data may be in various photorealistic and nonphotorealistic styles, such as cartoon-like rendering, pencil sketches, pen-and-ink illustrations, oil painting effects, and other painterly styles. The nonphotorealistic renderings may depict surfaces of objects and distinctive or well-known features of the objects.

User interface 16 may be disposed on a dashboard of a vehicle and may include a display screen 18 and a control device 20. Display screen 18 may include a processor and memory for controlling the information or content that is displayed on the screen or monitor. Generally, display screen 18 may present or depict image data received from engine 14.

Control device 20 may be in the form of a dial, knob, set of pushbuttons, joystick, microphone, or any combination of the above. A user may use control device 20 to provide feedback 22 to engine 14. Feedback 22 may include a user's selection of one of more above-described metrics that engine 14 may use to determine which objects to render in lower density and which objects to render in higher density. Feedback 22 may also instruct engine 14 to produce another set of image data (e.g., image data depicting another scene, object or set of objects). Alternatively, feedback 22 may instruct engine 14 to change the viewing angle at which a current set of image data is being viewed. The viewing angle may vary from an overhead bird's-eye view of the surroundings to an angle looking up at buildings, or at other landmarks, from a ground level or street level.

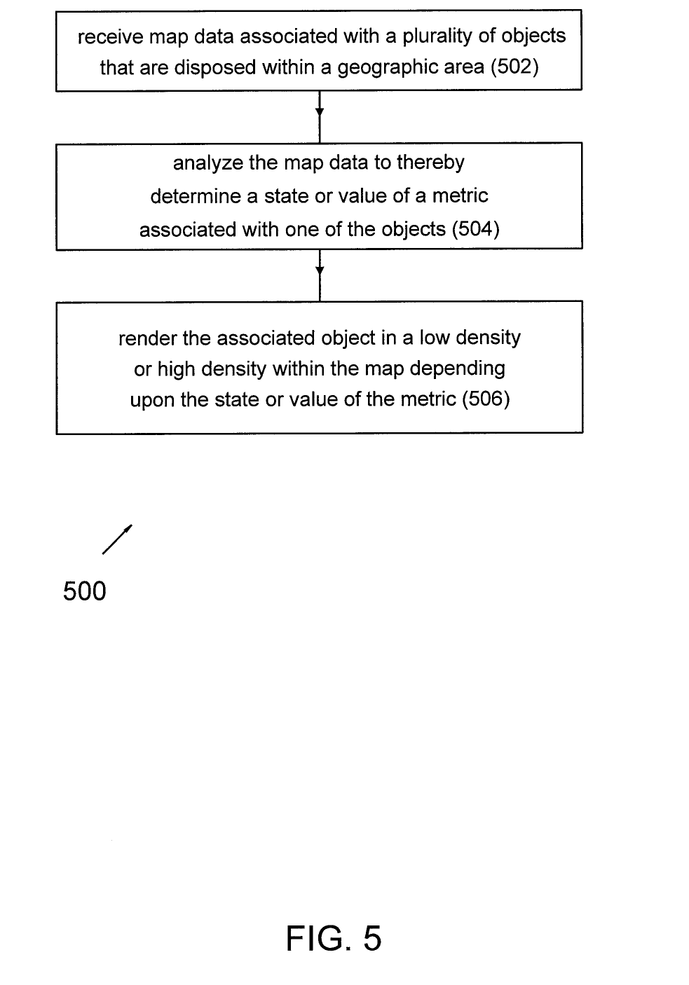

An embodiment of a method 500 of the present invention for displaying an electronic map is illustrated in FIG. 5. In a first step 502, map data is received that is associated with a plurality of objects that are disposed within a geographic area. For example, the arrangement of FIG. 4 may include a GPS or other location-determining device which may ascertain and continuously update the current location of the vehicle, which may be expressed in global coordinates. The map data received via the navigation system may include information about a geographical area that surrounds the vehicle. More particularly, the map data may include information about objects such as buildings, other structures, and natural features disposed in the geographical area that surrounds the vehicle. The data may include information about the exact location of each object and various visible and non-visible characteristics of each object, including its type, ownership, function, color, shape, surface texture, size, structure, and/or level of fame with the public, for example. Other map data may be received from inputs within the vehicle, such as the user's level of interest in, and/or familiarity with, particular objects, or particular types of objects.

Although the map data may be associated with a planned route of a vehicle, it is to be understood that the invention is not limited to maps that include a planned route. That is, the map may be of a specified geographic area without reference to any particular route extending through the geographic area.

In a next step 504, the map data is analyzed to thereby determine a state or value of a metric associated with one of the objects. For example, for a particular object such as a building in the electronic map, a metric may be calculated or otherwise determined based on an analysis of the map data received in step 502. The metric may be, for example, a level of interest of the user in the object, a measure of the relevance of the object to a planned route (e.g., distance between the object and the route, or distance between the object and a turn in the route), a function of the object, an ownership of the object, a level of visibility of the object to the user, a level of differentiation between the object and other objects in the area relative to some object characteristic, a color of the object, a surface texture of the object, a size, shape or structure of the object, a level of public fame of the object, or a level of familiarity of a particular user with the object.

Some metrics may be best described as having a finite number of possible non-numeric states. For example, the color metric, has possible states of blue, yellow, red, etc. As another example, the user interest metric may have only two states (e.g., the user is interested or not interested). Other metrics may be best described as having an infinite number of possible numeric values. For example, the size metric may be expressed as a single or multiple numeric values. As another example, the distance-to-route metric may have any of an infinite number of numeric values.

In a final step 506, the associated object is rendered in a low density or high density within the map depending upon the state or value of the metric. For example, if the determined metric is a level of interest in the object by the user, and it is determined on the basis of a low gasoline gauge that the user is interested in gas stations, then a particular object is rendered in high density if the object happens to be a gas station. However, if the particular object is not a gas station, then it is rendered in low density.

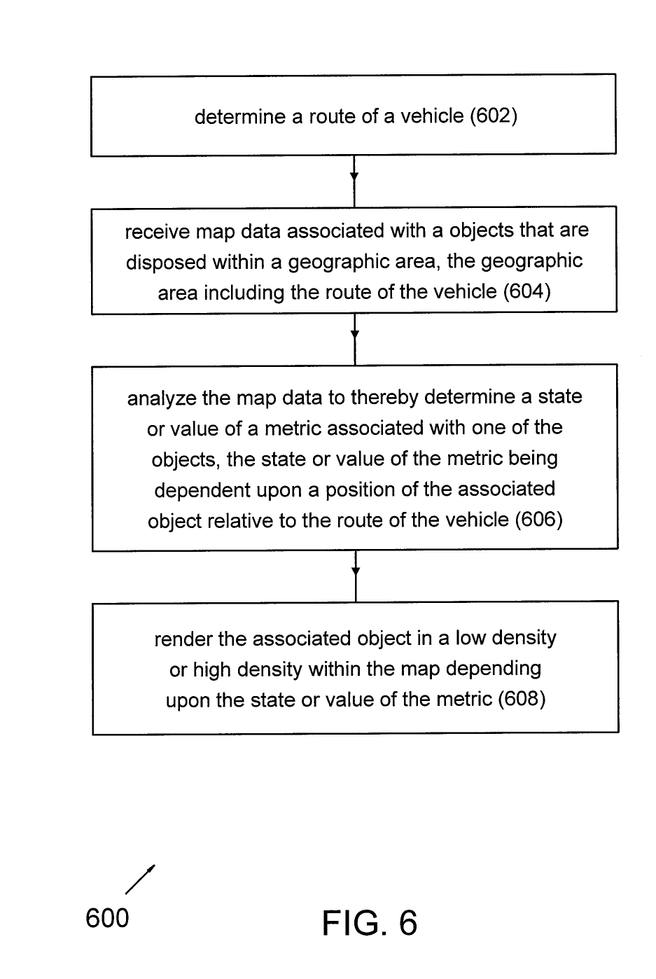

An embodiment of a method 600 of the present invention for displaying a navigation map is illustrated in FIG. 6. In a first step 602, a route of a vehicle is determined. For example, the arrangement of FIG. 4 may include a navigation system that automatically and continuously updates an optimum path or route from a vehicle's current location to a desired destination. The user inputs his desired destination into the system and the system automatically determines the shortest and/or quickest route from the current location to the destination location along the streets that are available. The route may follow a segment of each street included in the route, wherein the segment may be the entire length of the street or only a portion of the total length of the street.

In a next step 604, map data associated with objects that are disposed within a geographic area is received. The geographic area includes the route of the vehicle. For example, based on the vehicle's route determined in step 602, map data associated with the geographic area surrounding the route of the vehicle may be retrieved from a memory device, such as a CD. Alternatively, the map data associated with the geographic area surrounding the route of the vehicle may be wirelessly received from a central repository of map data. Regardless of how it is received, the map data may describe the shapes, dimensions, colors, functions, exact locations, surface textures, level of fame, and other characteristics of objects within the geographical area. The objects may include buildings, natural landmarks and other structures within the geographic area surrounding the route of the vehicle. The map data may also include the type or category of the buildings or other objects. The map data may also include other types of information such as the type of tenants in the building, lighting characteristics, etc.

Next, in step 606, the map data is analyzed to thereby determine a state or value of a metric associated with one of the objects. The state or value of the metric is dependent upon a position of the associated object relative to the route of the vehicle. For example, the distance-to-route metric may have a value that depends on how far an object is away from a closest point on the planned route. As another example, the adjacent-to-route metric have either a state of being adjacent to the route or a state of being non-adjacent to the route.

In a final step 608, the associated object is rendered either in a low density or high density within the map depending upon the state or value of the metric. For example, in the case of the distance-to-route metric, a distance of less than 100 feet between the object and a closest point on the planned route may result in the object being rendered in high density. Conversely, a distance of more than 100 feet between the object and a closest point on the planned route may result in the object being rendered in low density. As another example, in the case of the adjacent-to-route metric, an object that is adjacent to the planned route may be rendered in high density, while an object that is non-adjacent to the planned route may be rendered in low density.

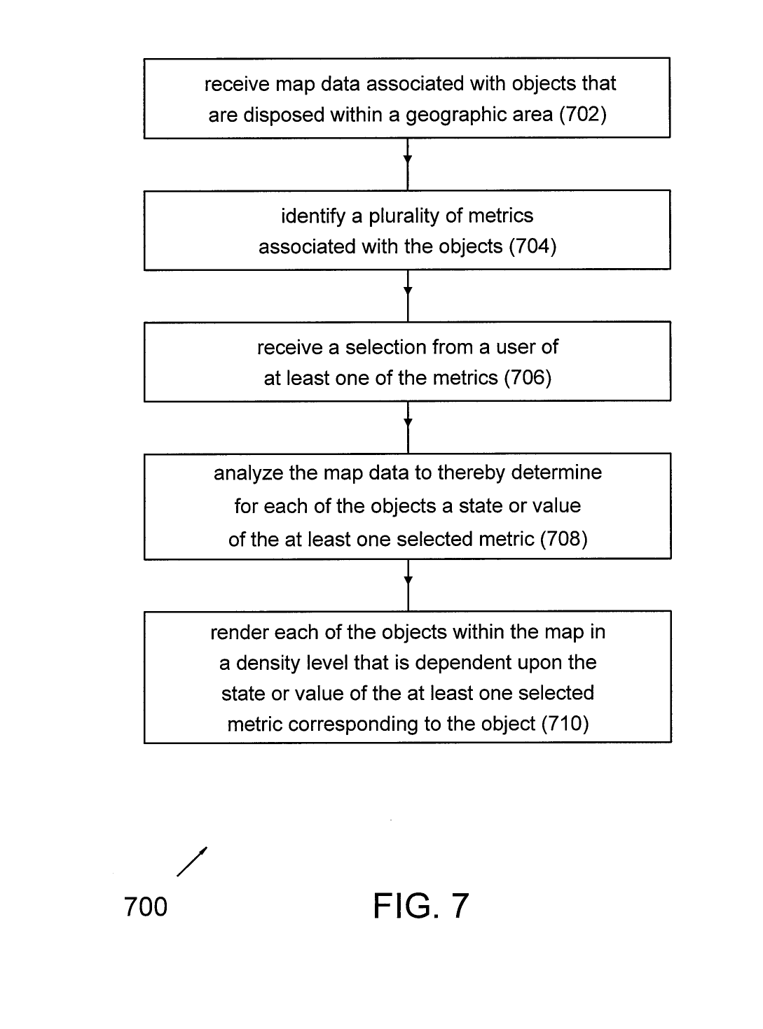

Another embodiment of a method 700 of the present invention for displaying an electronic map is illustrated in FIG. 7. In a first step 702, map data is received that is associated with a plurality of objects that are disposed within a geographic area. For example, the user may manually or orally enter into the system an identification of a location of which he would like to see a map, which may possibly be the user's present location or another location that he is thinking about driving to. The map data associated with the user-specified location may be received from a memory storage device within the vehicle. Alternatively, the map data may be received wirelessly via the Internet. The received map data may include information about a geographical area that surrounds the location specified by the user. More particularly, the map data may include information about objects such as buildings, other structures, and natural features disposed in the geographical area that surrounds the user-specified location. The data may include, for example, information about the exact geographical coordinates of each object and various visible and non-visible characteristics of each object, including its category, dimensions, tenants (in the case of a building), function, age, color, shape, surface texture, size, architectural style, and number of hits a text reference to the object produces on an on-line search engine (e.g., Google®), which may be used as a proxy for the object's level of fame with the public. Other map data may sourced from within the vehicle, such as the user's level of interest in, and/or familiarity with, particular objects, or particular types of objects. The user's interest in different types of objects, or in particular objects may be based on inputs provided by the user either on a previous occasion or in real time, perhaps in response to prompts from the system of the invention.

As described above, the map data may be associated with a planned route of a vehicle or with a route suggested by a navigation system. It is also possible for the map data to be independent of any street routes, and instead be associated with a geographic area that the user has specified. Such map data that is not associated with a route may be utilized on a desktop system or portable system that is not installed in a vehicle, but the map data may just as easily be utilized in an in-vehicle system.

In a next step 704, a plurality of metrics associated with the objects are identified. That is, any or all of the metrics described hereinabove in association with the dimensions of orientation, route relevance, and orientation may be offered for selection by a user. The metrics may include user interests, distance to route/distance to turn, and/or all of the orientation metrics, among others. Such metrics may be presented to the user on a menu on a display screen of an infotainment/navigation system of the present invention.

Next, in step 706, a selection is received from a user of at least one of the metrics. For example, the user may select one or more of the metrics presented to him on a menu, or he may provide his metric selection inputs without the benefit of a menu. The user is to understand that his metric selections are to determine the basis on which rendering density levels are established for the particular objects within the map.

Next, in step 708, the map data is analyzed to thereby determine for each of the objects a state or value of the at least one selected metric. For example, assume the user-selected metrics include a first combination of the distance-to-decision-point metric and the user-familiarity metric, and a second combination of the distance-to-decision-point metric and the differentiation metric. For example, any object that on the same block as a turning point on the planned route may be determined to have a state of being route-relevant, while any object that is not on a same block as a turning point on the planned route may be determined to have a state of being route-irrelevant. As another example, a McDonald's® golden arches sign may be determined to have a state of being familiar to the user on the basis of the famousness of the sign. Conversely, a retail outlet that has only one location may be determined to have a state of being unfamiliar to the user and thus may not be a good candidate for the user to use as a landmark for his upcoming turn. As yet another example, an unusually shaped sculpture may be determined to have a state of being highly differentiated from surrounding objects, and may make a good candidate for the user to use as a landmark for his upcoming turn. Conversely, a nondescript building having architecture similar to that of surrounding buildings may be determined to have a state of being not highly differentiated from surrounding objects.

In a final step 710, each of the objects within the map is rendered in a density level that is dependent upon the state or value of the at least one selected metric corresponding to the object. As a result of the above-described user-selections, any object that meets both of the two criteria of the first selection (i.e., is disposed within a predetermined distance of a turn on the planned route and is familiar to the user) is rendered in high density. For example, a famous McDonald's® golden arches sign that is within a block of a turn on the route is rendered in high density. Further, any object that meets both of the two criteria of the second selection (i.e., is disposed within a predetermined distance of a turn on the planned route and is visually very different from other nearby objects) is also rendered in high density. For example, an unusually shaped sculpture that is within a block of a turn on the route is rendered in high density. Any other object in the map that does not meet both criteria of the first combination selection and that does not meet both criteria of the second combination selection may be rendered in low density.

In the example above, objects are rendered in either of two discrete density levels (i.e., high or low). However, it is also possible for objects in a map to be rendered in more than two discrete density levels. In the example above, for instance, objects that meet one of the user selected criteria, but do not meet both of the criteria in either of the first and second combinations may be rendered in a medium density level. That is, there may be a third intermediate density level for objects that are within a block of the planned turn but that are neither familiar to the user nor highly differentiated. This third intermediate density level may also be assigned to objects that are familiar to the user and/or highly differentiated, but that are farther than a block from a turn on the route.

Nor is the invention limited to any discrete number of density levels. It is possible for objects to be assigned any of an infinite number of density levels from a continuous range of density levels. Such continuous density levels may be calculated based on one or more numeric metric values of an object to be rendered. For example, an object may be rendered with a density level that is an inversely-related, continuous function of the distance between the object and the route.

While this invention has been described as having an exemplary design, the present invention may be further modified within the spirit and scope of this disclosure. This application is therefore intended to cover any variations, uses, or adaptations of the invention using its general principles.

What is claimed is:

1. A method of displaying an electronic map, comprising the steps of:
receiving map data associated with a plurality of objects that are disposed within a geographic area;
analyzing the map data to thereby determine a state or value of a metric associated with one of the objects; and
rendering the associated object in a low density or high density within the map depending upon the state or value of the metric.

2. The method of claim 1 comprising the further step of determining a route of a vehicle, the route including at least one street segment on which the vehicle travels, the geographic area including the route of the vehicle, the value or state of the metric being dependent upon a calculated driving time from the route to the associated object and back to the route of the vehicle.

3. The method of claim 1 comprising the further step of determining a route of a vehicle, the route including at least one street segment on which the vehicle travels, the geographic area including the route of the vehicle, the value or state of the metric comprising a distance between:
the object and a closest point along the route of the vehicle; or
the object and a point along the route at which the vehicle is to make a turn.

4. The method of claim 1 wherein the value or state of the metric is dependent upon a user's level of interest in the associated object.

5. The method of claim 4 wherein the user's level of interest in the associated object is determined at least in part from sensor readings that are automatically taken within the vehicle.

6. The method of claim 1 comprising the further step of determining a route of a vehicle, the route including at least one street segment on which the vehicle travels, the geographic area including the route of the vehicle, wherein the value or state of the metric is dependent upon:
a level of visibility of the associated object to the user when in the vehicle and traveling along the route;
a level of differentiation between the associated object and other said objects within the geographic area;
a color of the associated object;
a level of texturing detail with which the associated object is to be rendered regardless of the level of density with which the object is rendered;
a size of the associated object;
a structure of the associated object; and/or
a level of familiarity of the associated object to the user.

7. The method of claim 1 comprising the further step of displaying an image including the associated object on a display screen within the vehicle.

8. A method of displaying a navigation map, comprising the steps of:
determining a route of a vehicle;
receiving map data associated with objects that are disposed within a geographic area, the geographic area including the route of the vehicle;
analyzing the map data to thereby determine a state or value of a metric associated with one of the objects, the state or value of the metric being dependent upon a position of the associated object relative to the route of the vehicle; and
rendering the associated object in a low density or high density within the map depending upon the state or value of the metric.

9. The method of claim 8 wherein the metric is dependent upon:
a distance between the associated object and a closest point along the route of the vehicle;
a distance between the associated object and a point along the route at which the vehicle is to make a turn; and/or
a calculated length of additional driving time that deviating from the route to visit the associated object would add to an original driving time associated with the route.

10. The method of claim 8 wherein the value or state of the metric is dependent upon a user's level of interest in the associated object, the user's level of interest in the associated object being determined at least in part from inputs provided by the user.

11. The method of claim 10 wherein the user's level of interest in the associated object is also determined from sensor readings that are automatically taken within the vehicle.

12. The method of claim 8 wherein the value or state of the metric is dependent upon:
a level of visibility of the associated object to the user;
a level of differentiation between the associated object and other said objects;
a color of the associated object;
a level of texturing in a surface of the associated object;
a size of the associated object;
a shape of the associated object; and/or a level of fame of the associated object.

13. The method of claim 8 comprising the further step of displaying an image of the associated object within the vehicle.

14. The method of claim 8 wherein the state or value of the metric is dependent upon whether other said objects are disposed between the associated object and a point along the route that is closest to the associated object.

15. A method of displaying an electronic map, comprising the steps of:
receiving map data associated with objects that are disposed within a geographic area;
identifying a plurality of metrics associated with the objects;
receiving a selection from a user of at least one of the metrics;
analyzing the map data to thereby determine for each of the objects a state or value of the at least one selected metric; and
rendering each of the objects within the map in a density level that is dependent upon the state or value of the at least one selected metric corresponding to said object.

16. The method of claim 15 comprising the further step of determining a route of a vehicle, the geographic area including the route of the vehicle, the value or state of at least one said metric being dependent upon a position of an associated said object relative to the route of the vehicle.

17. The method of claim 15 comprising the further step of determining a route of a vehicle, the route including at least one street segment on which the vehicle travels, the geographic area including the route of the vehicle, wherein the value or state of the at least one metric is dependent upon:
a level of visibility of an associated object to the user when in the vehicle and traveling along the route;
a level of differentiation between the associated object and other said objects within the geographic area;
a color of the associated object;
a level of texturing detail with which the associated object is to be rendered regardless of the level of density with which the object is rendered;
a size of the associated object;
a structure of the associated object; and/or
a level of familiarity of the associated object to the user.

18. The method of claim 15 comprising the further step of determining a route of a vehicle, the route including at least one street segment on which the vehicle travels, the geographic area including the route of the vehicle, the value or state of the at least one metric comprising a distance between:
an associated object and a closest point along the route of the vehicle; or
the object and a point along the route at which the vehicle is to make a turn.

19. The method of claim 15 wherein the value or state of the at least one metric is dependent upon a user's level of interest in an associated object.

20. The method of claim 19 wherein the user's level of interest in the associated object is determined at least in part based upon sensor readings that are automatically taken within the vehicle.
